(19) United States
(12) Patent Application Publication
(10) Pub. No.: US 2007/0189418 A1
(43) Pub. Date: Aug. 16, 2007

(54) Demodulator and optical disk device having the same

(75) Inventor: Masaichi Takai, Kyoto (JP)

Correspondence Address: Fish & Richardson PC;Citigroup Center, 153 East 53rd Street, 52nd Floor, New York, NY, 10022-4611, US

(73) Assignee: ROHM CO., LTD., Kyoto (JP)

(21) Appl. No.: 11/570,640

(22) PCT Filed: Jul. 1, 2005
(86) PCT No.: PCT/JP05/12203

§ 371 Date: Dec. 14, 2006

(30) Foreign Application Priority Data
Jul. 12, 2004 (JP) 2004-205317

(51) Int. Cl. H04L 27/00

(52) U.S. Cl. 375/316

(57) ABSTRACT

A demodulator reads a slice signal input to a slice signal input terminal, and demodulates a data word from a code word to output the demodulated data word to a data word output terminal. The demodulator includes a main demodulation table which, when a code word not violating a minimum inversion interval is input, outputs a data word corresponding to the code word, and a violation demodulation table which, when a code word violating the minimum inversion interval is input, outputs a data word which corresponds to the code word and is assumed to be correct.

### TECHNICAL FIELD

The present invention relates to a demodulator in the signal reproduction process and an optical disk device having the demodulator.

### BACKGROUND ART

An optical disk device for such as a compact disk (CD) and a digital versatile disk (DVD) has a basic configuration for the signal reproduction process as shown in FIG. 5. That is, an optical disk device 51 utilizes a photodetector 60 to detect an optical signal provided by a mark formed on an optical disk 59. The detected signal is amplified by a RF amplifier 61 and is output as a RF signal. The RF signal is output as a corrected RF signal having a high-pass frequency component corrected by an equalizer 62. The corrected RF signal is binalized (sliced) by a slicer 63 to be output as a slice signal. A demodulator 65 reads the slice signal to demodulate (reproduce) a data word from a code word. In addition, the slice signal is input into a reproduction clock generator 64 to thereby generate a clock for reproduction. An error corrector 66 uses an error correcting code (ECC) to perform an error correction for the data word output by demodulator 65.

FIG. 6 shows signal waveforms of each part in the signal reproduction process. (A) represents a RF signal, (B) represents a slice signal and (C) represents a signal waveform of a clock for reproduction. The length of a mark and the interval between the marks on the optical disk correspond to the number of successive “1”s or “0”s. Since the signals before and after the RF signal have an influence on each other (cause intersymbol interference), the RF signal has a large amplitude when the length of the mark or the interval between the marks is large, whereas the RF signal has a small amplitude when the length of the mark or the interval between the marks is short. The slice signal is obtained by the binalization with the average voltage of the RF signal serving as a reference. Furthermore, the clock for reproduction is obtained by a PLL (phase locked loop)-control of a phase and a frequency by the slice signal.

Thus, the RF signal has a small amplitude when the length of the mark or the interval between the marks are short. Therefore, the RF signal is subject to influence from noise or jitter of the time axis, and, when the code word including the influenced part is demodulated by demodulator 65, an error may often occur in the data word. Although error corrector 66 performs error correction of the data word having an error to thereby reduce the error rate, the fact is that the corrected error rate is high if the error rate of the input data word is high.

For example, techniques described in Japanese Patent Laying-Open No. 6-290463 (patent document 1) or Japanese Patent Laying-Open No. 11-096691 (patent document 2) are proposed in order to reduce the error caused by the intersymbol interference. That is, the error rate may be reduced by the respective schemes such as utilizing an equalizer described in the patent document 1 and devising a constraint rule of the code word described in the patent document 2.

Patent Document 1: Japanese Patent Laying-Open No. 6-290463

Patent Document 2: Japanese Patent Laying-Open No. 11-096691

### DISCLOSURE OF THE INVENTION

Problems to be Solved by the Invention

In recent years, however, there is an increasing need for improved performance also in the signal reproduction process, that is, a reduced error rate in order to further improve the performance of the optical disk device.

The present invention has been made in light of the above-described reasons, and an object of the present invention is to provide a demodulator capable of reducing an error rate in the signal reproduction process of an optical disk device and the optical disk device capable of improving the performance by having the demodulator.

Means for Solving the Problems

In order to solve the above-mentioned problems, the demodulator according to the present invention, which reads an input slice signal to demodulate a data word from a code word, includes a main demodulation table which, when a code word not violating a minimum inversion interval is input, outputs a data word corresponding to the code word, and a violation demodulation table which, when a code word violating the minimum inversion interval is input, outputs a data word which corresponds to the code word and is assumed to be correct.

Furthermore, the optical disk device according to the present invention includes a demodulator reading an input slice signal to demodulate a data word from a code word, and, in a stage subsequent to the demodulator, an error corrector into which the demodulated data word is input. The demodulator includes a main demodulation table which, when a code word not violating a minimum inversion interval is input, outputs a data word corresponding to the code word, and a violation demodulation table which, when a code word violating the minimum inversion interval is input, outputs a data word which corresponds to the code word and is assumed to be correct.

Effects of the Invention

The demodulator according to the present invention can repair the error within a certain range by providing, in addition to a main demodulation table, a violation demodulation table used for the code word which violates the minimum inversion interval, and therefore can more effectively reduce the error rate. Furthermore, the optical disk device according to the present invention can improve the performance in the signal reproduction process by providing this demodulator.

### BRIEF DESCRIPTION OF THE DRAWINGS

FIG. 1 is a block diagram of a configuration of a demodulator according to an embodiment of the present invention.

FIG. 2 is a configuration diagram of a main demodulation table according to the embodiment of the present invention.

FIG. 3 is a configuration diagram of a violation demodulation table according to the embodiment of the present invention.

FIG. 4 is another configuration diagram of the violation demodulation table according to the embodiment of the present invention.

FIG. 5 is a block diagram of a conventional optical disk device.

FIG. 6 shows waveform diagrams of each part of the conventional optical disk device.

### DESCRIPTION OF THE REFERENCE SIGNS

1 demodulator, 14 main demodulation table, 15 violation demodulation table, IN slice signal input terminal, CLK reproduction clock input terminal, OUT data word output terminal, 51 optical disk device

### BEST MODES FOR CARRYING OUT THE INVENTION

The embodiments of the present invention will be hereinafter described in detail with reference to the accompanying drawings, in which the same or corresponding components in each figure are designated by the same reference characters, and description thereof will not be repeated.

A demodulator according to an embodiment of the present invention will be hereinafter described. The demodulator 1 is used as a demodulator 65 in a signal reproduction process of an optical disk device 51 shown in the above-mentioned FIG. 5, reads a slice signal input from a slicer 63 to demodulate (reproduce) a data word from a code word, and outputs this data word to an error corrector 66. Furthermore, a clock for reproduction is input from a reproduction clock generator 64.

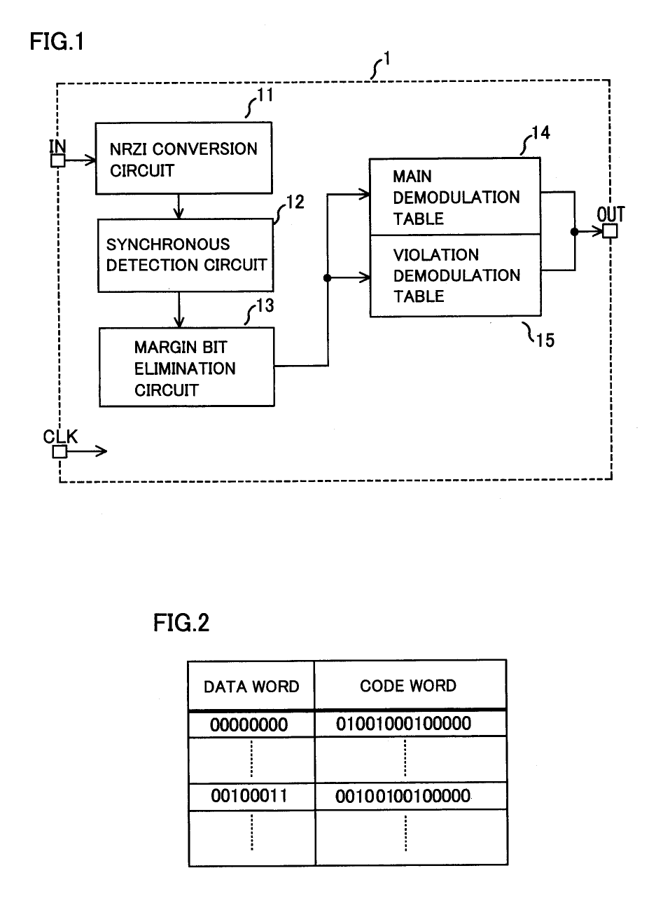

FIG. 1 is a block diagram showing a configuration of demodulator 1 according to an embodiment of the present invention.

Referring to FIG. 1, demodulator 1 according to the embodiment of the present invention includes two input terminals, that is, a slice signal input terminal IN into which a slice signal is input and a reproduction clock input terminal CLK into which a clock for reproduction is input, and one output terminal, that is, a data word output terminal OUT outputting a demodulated data word. The clock for reproduction which is not shown is input into respective blocks configuring demodulator 1 to become a reference clock for their operation. Slice signal input terminal IN has connected thereto an NRZI conversion circuit 11 which reads the slice signal to NRZI (Non Return to Zero Inverted)-convert the data of “1” and “0”. Connected at a stage subsequent to NRZI conversion circuit 11 is a synchronous detection circuit 12, which detects a break to divide the data into words each having a code word and a margin bit. Connected at a stage subsequent to synchronous detection circuit 12 is a margin bit elimination circuit 13, which removes the margin bit and leaves the code word. It should be noted that the margin bit is added to the code word so as to conform to the constraint rule of the data stored in an optical disk.

Connected at a stage subsequent to margin bit elimination circuit 13 are a main demodulation table 14 and a violation demodulation table 15, each of which outputs the data word corresponding to an input code word to data word output terminal OUT. When a code word not violating a minimum inversion interval is input, main demodulation table 14 outputs the data word corresponding to the code word. When a code word violating the minimum inversion interval is input, violation demodulation table 15 outputs the data word which corresponds to the code word and is assumed to be correct. The minimum inversion interval refers to the shortest length of a mark on the optical disk or the shortest interval between such marks, that is, the number of successive “1”s or “0”s recorded on the optical disk.

The case in which demodulator 1 is used for a CD device will then be specifically described. The modulation scheme that is used for the CD device is an EFM (Eight to Fourteen Modulation) scheme. In this case, since the code word is 14 bits and the margin bits are 3 bits, synchronous detection circuit 12 divides the data into words each having 17 bits. Margin bit elimination circuit 13 removes the 3 margin bits and leaves the code word of 14 bits. Main demodulation table 14 and violation demodulation table 15 each receive the code word of 14 bits and output a data word of 8 bits.

FIG. 2 is a configuration diagram of a main demodulation table 14 according to the embodiment of the present invention.

For example, when 01001000100000 is input as a code word, 00000000 is output as a data word. In addition, when 00100100100000 is input as a code word, 00100011 is output as a data word. In the case of the EFM scheme, the one-to-one relation between the code word and the data word, and the data word having 8 bits result in 256 types of associations between the code words and the data words.

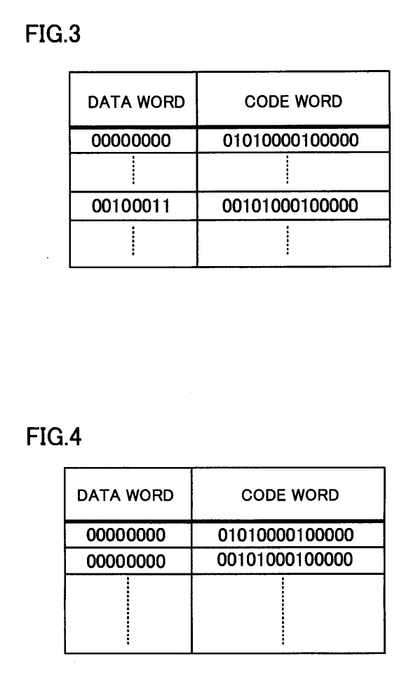

FIG. 3 is a configuration diagram of a violation demodulation table 15 according to the embodiment of the present invention.

For example, when 01010000100000 is input as a code word, it is assumed that an error occurs in a code word of 01001000100000, and 00000000 is output as a data word which is assumed to be correct. Furthermore, when 00101000100000 is input as a code word, it is assumed that an error occurs in a code word of 00100100100000 and 00100011 is output as a data word which is assumed to be correct. The number of the associations between the code words and the data words depends on the number of the code words which are assumed to be caused due to error, and there are 282 types of associations therebetween as one embodiment. In main demodulation table 14, even if 01010000100000 and 00101000100000 are input as a code word, there is no data word corresponding to them, and therefore, no data word is output.

According to the constraint rule, the minimum inversion interval in the EFM scheme is 3 T assuming that the length on the optical disk corresponding to 1 bit (one “1” or “0”) is T. That is, the number of successive “1”s or “0”s recorded on the optical disk is three. If this is translated into the code word after the NRZI conversion, there are at least two “0”s between “1” and “1” configuring the code word according to the constraint rule.

Referring to a specific example in the EFM scheme, the operation of the signal reproduction process will then be described focusing on demodulator 1. When the code word 01110000111111 before the NRZI conversion which is recorded on the optical disk is read, there is a possibility that an error may occur in the mark of data 111 in which the original length is 3 T, to thereby cause the length to be 2 T, and thus, the code word may be changed to 01100000111111. When the normal code word 01110000111111 is NRZI-converted (when there is a data inversion, 1 is assigned, and when there is no data inversion, 0 is assigned), it is converted to the code word 01001000100000, and demodulated to the data word 00000000 in main demodulation table 14. On the other hand, when the code word having an error, 01100000111111, is NRZI-converted, it is converted to the code word 01010000100000, and is demodulated in violation demodulation table 15 to the data word 00000000 which is assumed to be correct.

When the code word 00111000111111 before the NRZI conversion which is recorded on the optical disk is read, there is a possibility that an error may occur in the mark of data 111 in which the original length is 3 T, to thereby cause the length to be 2 T, and thus, the code word may be changed to 00110000111111. When the normal code word 00111000111111 is NRZI-converted, it is converted to the code word 00100100100000, and demodulated to the data word 00100011 in main demodulation table 14. On the other hand, when the code word having an error, 00110000111111, is NRZI-converted, it is converted to the code word 00101000100000, and is demodulated in violation demodulation table 15 to the data word 00100011 which is assumed to be correct.

In this way, despite that an error occurs in the code word, it is possible to repair the error and demodulate the code word to a correct data word. This is because the minimum inversion interval is fixed by the constraint rule, so that it is possible to determine that an error occurs without fail if there is a shorter inversion interval than the minimum inversion interval.

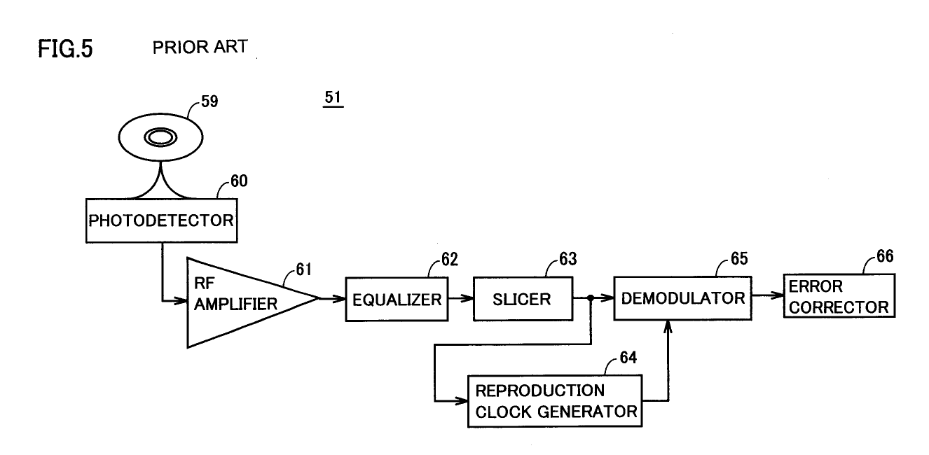

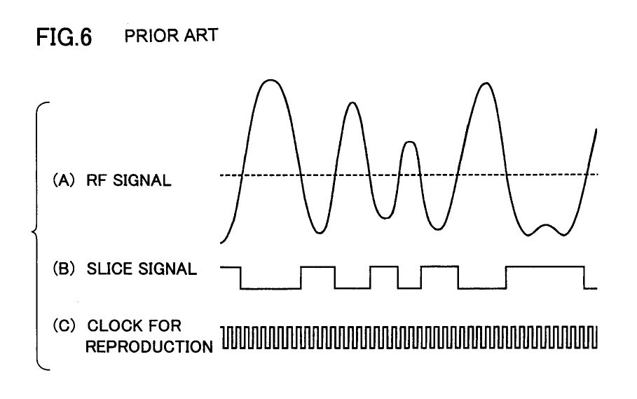

In the following description will be described a case in which there are more than one normal code word which is conceivable from the code word having an error. For example, when the code word 01110000111111 before the NRZI conversion which is recorded on the optical disk is read, there is a possibility that the code word may be changed to 00110000111111. This code word 00110000111111 is, as described above, the same as the code word having the error in the case where the code word 00111000111111 recorded on the optical disk is read. After the NRZI conversion, the code word having the error, 00110000111111, is demodulated to the data word 00100011 by using violation demodulation table 15 shown in FIG. 3. This is because a priority is placed on the case for which the decision is made, as based on the experimental data and the like, that there is a higher probability that a code word will change to 00110000111111. Therefore, in some cases, the code word 00110000111111 can also be demodulated to the data word 00000000 after the NRZI conversion, by using another violation demodulation table 15 according to the embodiment of the present invention as shown in FIG. 4 in place of violation demodulation table 15.

In this way, it is possible to repair the error in the minimum inversion interval (3 T in the EFM scheme) on the optical disk within a certain range by violation demodulation table 15. In the minimum inversion interval on the optical disk, the amplitude of a RF signal tends to become small (e.g., 150 mV) and to be an error due to noise or jitter. In addition, there is a high possibility of occurrence of the minimum inversion interval. Therefore, the repairing can reduce the error rate effectively, for example, by more than 10% according to the experiment by the present inventor. Thus, it is possible to improve the performance of the optical disk device in the signal reproduction process by providing this demodulator 1.

The present invention is not be limited to the above-mentioned embodiment, but can be variously changed in its design within the range of the matters described in the appended claims. For example, although the EFM used in the CD device has been particularly described in the embodiment, the present invention can also be applied to a 8/16 modulation used in a DVD device. The NRZI conversion circuit, the synchronous detection circuit and the margin bit elimination circuit configuring the demodulator of the present embodiment may also be replaced by other circuits or be omitted depending on the modulation scheme used by the optical disk device.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

What is claimed is:

1. A demodulator reading an input slice signal to demodulate a data word from a code word, comprising:
a main demodulation table which, when a code word not violating a minimum inversion interval is input, outputs a data word corresponding to the code word; and
a violation demodulation table which, when a code word violating the minimum inversion interval is input, outputs a data word which corresponds to the code word and which is assumed to be correct.

2. An optical disk device comprising:
a demodulator reading an input slice signal to demodulate a data word from a code word; and
in a stage subsequent to said demodulator, an error corrector into which the demodulated data word is input, wherein said demodulator includes
a main demodulation table which, when a code word not violating a minimum inversion interval is input, outputs a data word corresponding to the code word, and
a violation demodulation table which, when a code word violating the minimum inversion interval is input, outputs a data word which corresponds to the code word and which is assumed to be correct.
